(19) United States
(12) Patent Application Publication
(10) Pub. No.: US 2025/0280200 A1
(43) Pub. Date: Sep. 4, 2025

(54) IMAGING APPARATUS, CONTROL METHOD, AND STORAGE MEDIUM

(71) Applicant: CANON KABUSHIKI KAISHA, Tokyo (JP)

(72) Inventor: SHOKO YOKOMIZO, Kanagawa (JP)

(21) Appl. No.: 19/060,392

(22) Filed: Feb. 21, 2025

(30) Foreign Application Priority Data
Feb. 29, 2024 (JP) 2024-030013

(51) Int. Cl. H04N 23/69; H04N 23/695

(52) U.S. Cl. CPC H04N 23/69; H04N 23/695

(57) ABSTRACT

An imaging apparatus includes a first and a second imaging units that rotate about a common rotation axis, a zoom drive unit that changes zoom magnifications of the first and the second imaging units, a pan drive unit that rotates the first and the second imaging units about the common rotation axis, a memory storing instructions and a processor executing the instructions to determine whether the first and the second imaging units are close to or contacting, and, in a case it is determined that the first and the second imaging units are close to or contacting, the zoom drive unit is controlled to change at least one of the zoom magnification of the first imaging unit or the zoom magnification of the second imaging unit.

### BACKGROUND

### Field

The present disclosure relates to an imaging apparatus that includes a plurality of rotatable imaging units.

### Description of the Related Art

In order to enable a single camera to capture images in a plurality of directions, there is a camera configured with a plurality of imaging units (hereinbelow, referred to as a multi-lens camera). In such a multi-lens camera, each imaging unit can move independently around a common rotation axis on the same circumference. A user can control an imaging position of each imaging unit with a personal computer (PC) enabling easily setting an imaging position.

Japanese Patent Application Laid-Open No. 2020-188349 discusses an imaging apparatus that can control an imaging direction of each multi-lens camera. In an imaging apparatus in which each imaging unit can independently rotate about a common rotation axis, operating the imaging position of each imaging unit may cause the imaging unit to contact an adjacent imaging unit. In a case where the imaging unit in a high zoom magnification state contacts the adjacent imaging unit, there is a possibility that an imaging range of the operated imaging unit does not overlap with an imaging range of the adjacent imaging unit. Thus, there is a risk that a range that a user cannot check exists between the imaging ranges of the imaging units. Even in a case where the operated imaging unit does not contact the adjacent imaging unit, there is a possibility that the imaging range of the operated imaging unit does not overlap with the imaging range of the adjacent imaging unit if the imaging unit is installed to approach the adjacent imaging unit in the high zoom magnification state.

The imaging apparatus discussed in Japanese Patent Application Laid-Open No. 2020-188349 outputs images acquired by the respective imaging units in a case where the images acquired by two imaging units cannot be combined. Thus, there is a risk that a range that a user cannot check exists between the imaging ranges of the imaging units.

### SUMMARY

According to an aspect of the present disclosure, an imaging apparatus includes a first imaging unit and a second imaging unit configured to rotate about a common rotation axis, a zoom drive unit configured to drive zoom lenses to change a zoom magnification of the first imaging unit and a zoom magnification of the second imaging unit, a pan drive unit configured to rotate the first imaging unit and the second imaging unit about the common rotation axis, one or more memories storing instructions, and one or more processors executing the instructions to determine whether the first imaging unit and the second imaging unit are close to each other or contacting. In a case where it is determined that the first imaging unit and the second imaging unit are close to each other or contacting, the zoom drive unit is controlled to change at least one of the zoom magnification of the first imaging unit or the zoom magnification of the second imaging unit.

Further features of the present disclosure will become apparent from the following description of exemplary embodiments with reference to the attached drawings.

### BRIEF DESCRIPTION OF THE DRAWINGS

FIG. 1 is a block diagram illustrating a functional configuration of a system according to a first exemplary embodiment.

FIG. 2 illustrates an arrangement of imaging units according to the first exemplary embodiment.

FIG. 3A illustrates imaging ranges before angles of view of the imaging units according to the first exemplary embodiment are changed.

FIG. 3B illustrates imaging ranges after the angles of view of the imaging units according to the first exemplary embodiment are changed.

FIG. 4 is a flowchart illustrating operations of an imaging apparatus according to the first exemplary embodiment.

FIG. 5A illustrates imaging ranges before angles of view of the imaging units according to a second exemplary embodiment are changed.

FIG. 5B illustrates imaging ranges after the angles of view of the imaging units according to the second exemplary embodiment are changed.

FIG. 6 is a flowchart illustrating operations of an imaging apparatus according to the second exemplary embodiment.

FIG. 7A illustrates an overlap of captured images in the case of FIG. 5B.

FIG. 7B illustrates imaging ranges after settings of the imaging units according to a third exemplary embodiment are changed.

FIG. 8 is a flowchart illustrating operations of an imaging apparatus according to the third exemplary embodiment.

### DESCRIPTION OF THE EMBODIMENTS

Exemplary embodiments of the present disclosure will be described in detail below with reference to the attached drawings. The exemplary embodiments described below are not seen to be limiting. All features described in the exemplary embodiments are not always essential, and any of the features may be combined. The same or similar configurations in the attached drawings are denoted by the same reference numerals, and redundant descriptions are omitted.

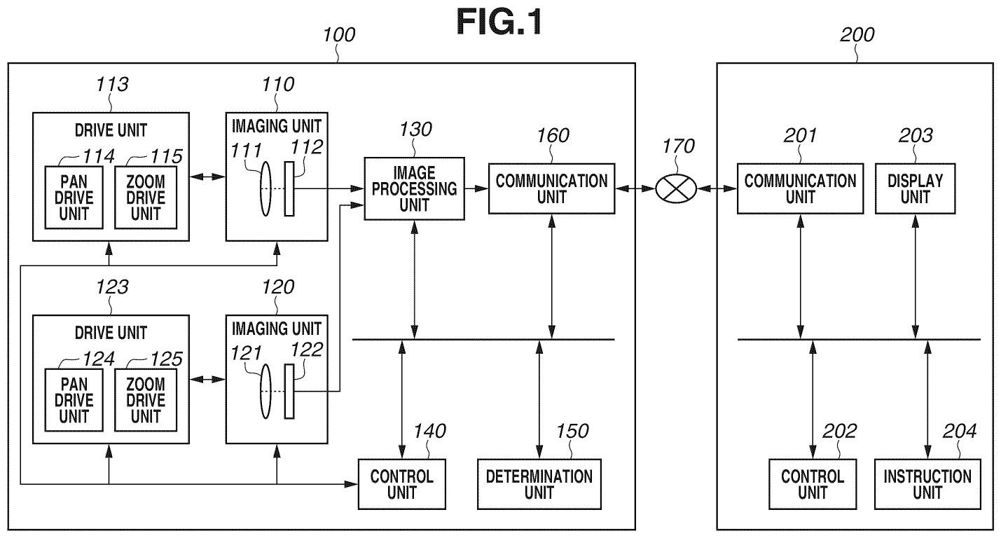

FIG. 1 is a block diagram illustrating the functional configuration of the system according to the present exemplary embodiment. An imaging apparatus 100 includes a first imaging unit 110, a second imaging unit 120, a first drive unit 113, a second drive unit 123, an image processing unit 130, a control unit 140, a determination unit 150, and a communication unit 160.

The imaging apparatus 100 is connected to an external control apparatus 200 via a network 170. The imaging apparatus 100 can transmit image data acquired by the imaging apparatus 100 or receive a control signal for the imaging apparatus 100.

The first imaging unit 110 and the second imaging unit 120 respectively include image forming optical systems 111 and 121 and solid-state imaging devices 112 and 122. Light transmitted through the image forming optical systems 111 and 121 forms images on the solid-state imaging devices 112 and 122, is converted into electrical signals, and is output as image data through processing in the image processing unit 130. Driving and signal readout of each of the solid-state imaging devices 112 and 122 are controlled by the control unit 140.

The image forming optical systems 111 and 121 in the first imaging unit 110 and the second imaging unit 120 include zoom lenses that can move in an optical axis direction, and imaging ranges of the imaging units can be controlled by the control unit 140 controlling a first zoom drive unit 115 and a second zoom drive unit 125.

The first drive unit 113 and the second drive unit 123 include a first pan drive unit 114 and a second pan drive unit 124, and the first zoom drive unit 115 and the second zoom drive unit 125, respectively.

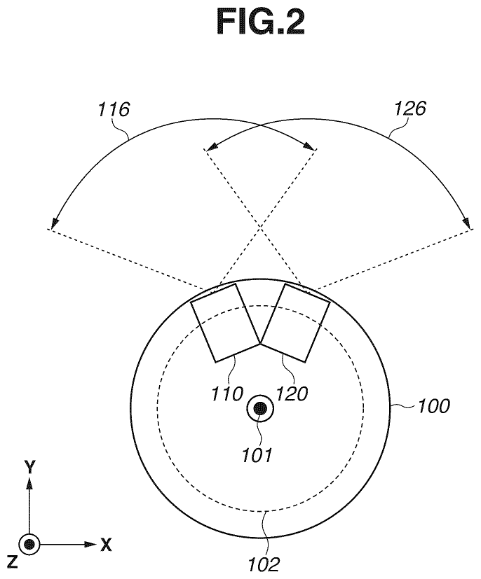

The first pan drive unit 114 and the second pan drive unit 124 can control imaging directions of the first imaging unit 110 and the second imaging unit 120, respectively, in the same plane (in an XY plane in FIG. 2). A more specific description will be provided with reference to FIG. 2.

FIG. 2 illustrates an arrangement of the imaging units according to the present exemplary embodiment, with the imaging apparatus 100 viewed from above (+Z axis side). The first pan drive unit 114 and the second pan drive unit 124 each include motors and gears. The first pan drive unit 114 and the second pan drive unit 124 can also drive and rotate the first imaging unit 110 and the second imaging unit 120 about an axis 101 as a common rotation axis by controlling power that drives the motors. A dotted line 102 indicates a common rotation range in which the first imaging unit 110 and the second imaging unit 120 can rotate about the axis 101 as the rotation axis. The power for driving the motors is controlled by the control unit 140. The imaging apparatus 100 includes a drive mechanism that can control the imaging direction of at least one of the first imaging unit 110 or the second imaging unit 120.

The first zoom drive unit 115 and the second zoom drive unit 125 each include motors and gears. The first zoom drive unit 115 and the second zoom drive unit 125 can also drive the zoom lenses included in the image forming optical systems by controlling the power that drives the motors. The power for driving the motors is controlled by the control unit 140. Positions of the zoom lenses can be acquired by a photointerrupter, a Hall element, or the like. Angles of view 116 and 126 indicate angles of view at which the first imaging unit 110 and the second imaging unit 120 respectively capture images. The imaging apparatus 100 includes a drive mechanism that can control the angle of view (imaging range) of at least one of the first imaging unit 110 or the second imaging unit 120.

The control unit 140 controls the first imaging unit 110, the second imaging unit 120, the first drive unit 113, the second drive unit 123, the image processing unit 130, the determination unit 150, and the communication unit 160. The control unit 140 is configured with a central processing unit (CPU) and other components and integrally controls the imaging apparatus 100. The control unit 140 can control at least one of the first drive unit 113 or the second drive unit 123 based on a determination result of the determination unit 150.

The determination unit 150 determines whether the first imaging unit 110 and the second imaging unit 120 are close to each other or contacting in a pan rotation direction. Specifically, the determination unit 150 determines whether a distance between the first imaging unit 110 and the second imaging unit 120 in the pan rotation direction is a threshold value or less. The distance between the first imaging unit 110 and the second imaging unit 120 in the pan rotation direction is calculated from information regarding the positions of the first imaging unit 110 and the second imaging unit 120. The information regarding the positions of the first imaging unit 110 and the second imaging unit 120 includes, for example, the number of rotations of the first pan drive unit 114 and the second pan drive unit 124, and rotation angles of the first imaging unit 110 and the second imaging unit 120 in the pan rotation direction.

For example, the distance is acquired by calculating the positions in the pan rotation direction from the number of rotations of the motors of the first pan drive unit 114 and the second pan drive unit 124. Alternatively, the rotation angles in the pan rotation direction of the first imaging unit 110 and the second imaging unit 120 may be used to determine that they are close to each other or contacting without calculating the distance in a case where the rotation angles are the threshold value or less. Alternatively, it may be directly determined that the imaging units are close to each other or contacting using a sensor that detects that the imaging units are physically contacting or close to each other without calculating the distance. Alternatively, it may be directly determined that the imaging units are close to each other or contacting using a sensor that detects a distance between the imaging units without calculating the distance. The threshold value is assumed to be set in advance. Thereafter, the determination unit 150 notifies the control unit 140 of the determination result.

The communication unit 160 transfers an image transmitted from the image processing unit 130 to the external control apparatus 200 via the network 170, such as a wired or wireless network.

The external control apparatus 200 includes a communication unit 201, a control unit 202, a display unit 203, and an instruction unit 204. The communication unit 201 of the external control apparatus 200 can communicate with the imaging apparatus 100 via the network 170. The display unit 203 can display image data of the first imaging unit 110 and image data of the second imaging unit 120, respectively, transmitted from the imaging apparatus 100. The instruction unit 204 includes a user interface, receives an operation performed by a user on a mouse or a keyboard, and generates a control signal for controlling the imaging apparatus 100 using the control unit 202. The control signal is, for example, a signal for controlling the first drive unit 113 and the second drive unit 123. In other words, the user can control, from the external control apparatus 200 via the network 170, imaging positions or zoom magnifications of the first imaging unit 110 and the second imaging unit 120. The user can also specify, from the external control apparatus 200 via the network 170, the imaging ranges of the first imaging unit 110 and the second imaging unit 120.

The control apparatus 200 serving as an external apparatus is, for example, an external apparatus such as a personal computer (PC). The network 170 is configured with a wired local area network (LAN), a wireless LAN, and the like. The imaging apparatus 100 can be supplied with power via the network 170.

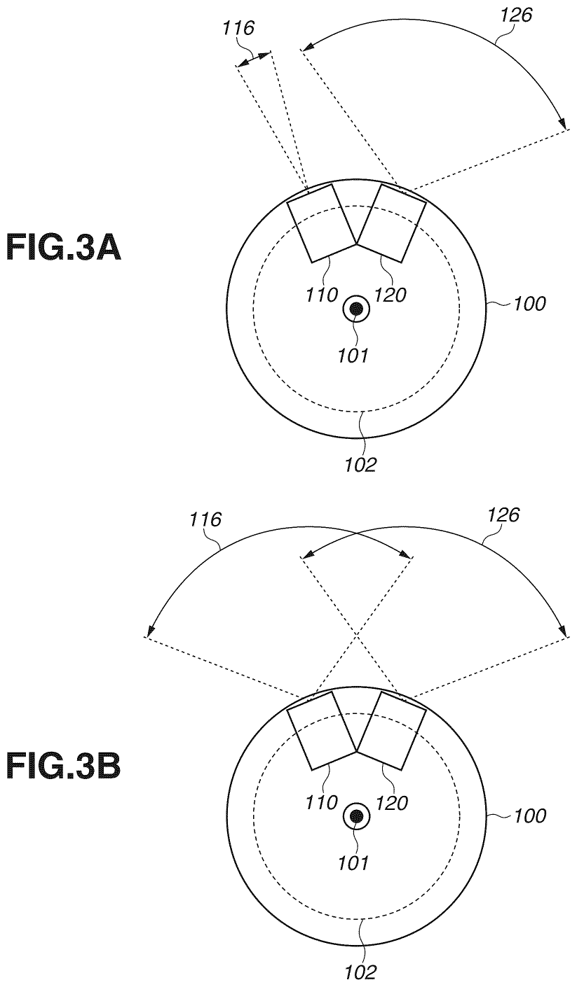

An operation of the imaging apparatus 100 according to the present exemplary embodiment will be described below with reference to FIGS. 3A and 3B. According to the present exemplary embodiment, a case will be described in which the first imaging unit 110 is driven to pan by a user operation, which causes the first imaging unit 110 to contact the second imaging unit 120 that is not moving. According to the present exemplary embodiment, it is also assumed that the second imaging unit 120 has already been installed, and the angle of view of the second imaging unit 120 is not changed. Here, the term “installed” may refer to a situation that is set by a user, in which a change is made from a previous setting, or in which the change in setting is stored. According to the present exemplary embodiment, an example in which a user performs pan driving on the first imaging unit 110 is described, but the same applies to a case in which pan driving is performed on the second imaging unit 120 instead of the first imaging unit 110, so that the description thereof is omitted herein.

FIG. 3A illustrates the imaging ranges before the angles of view of the imaging units according to the present exemplary embodiment are changed. FIG. 3B illustrates the imaging ranges after the angles of view of the imaging units according to the present exemplary embodiment are changed.

In both FIGS. 3A and 3B, the first imaging unit 110 and the second imaging unit 120 are contacting. FIG. 3A also illustrates a state in which the first imaging unit 110 images at a high zoom magnification. Since the first imaging unit 110 and the second imaging unit 120 are driven on the common rotation axis 101, the first imaging unit 110 cannot perform pan driving if the first imaging unit 110 contacts the second imaging unit 120 and reaches a position where it cannot move. For example, in a case where the user performs pan driving on the first imaging unit 110 through an operation from the instruction unit 204 and causes the first imaging unit 110 to contact the second imaging unit 120, the angle of view is too narrow to check the surroundings and make adjustment difficult if the first imaging unit 110 images at the high zoom magnification. In a case where the first imaging unit 110 and the second imaging unit 120 come close to each other even if they do not move to a position where they contact, the angle of view is too narrow to check the surroundings and make adjustment difficult if the first imaging unit 110 images at the high zoom magnification.

Thus, according to the present exemplary embodiment, the angle of view 116 of the first imaging unit 110 is changed to a wide-angle side as illustrated in FIG. 3B if the determination unit 150 determines that the first imaging unit 110 comes close to or contacts the second imaging unit 120. Specifically, in a case where the determination unit 150 determines that the distance between the first imaging unit 110 and the second imaging unit 120 is the threshold value or less, the determination unit 150 determines that the first imaging unit 110 and the second imaging unit 120 are in a first state in which they are close to each other or in a second state in which they are contacting.

The first state refers to a state in which the first imaging unit 110 and the second imaging unit 120 are not contacting but are close to each other. Whether to determine that the state is the first state or the second state can also be changed by a setting of the threshold value. For example, in a case where the threshold value is set to a distance at which the first imaging unit 110 and the second imaging unit 120 contact, it is determined whether they are in the second state. In a case where the threshold value is set greater than the distance at which the first imaging unit 110 and the second imaging unit 120 contact, it is determined whether they are in the first state.

The determination unit 150 then transmits the determination result to the control unit 140. Upon receiving the determination result, the control unit 140 acquires a drive position of the first zoom drive unit 115. If the zoom magnification is high (telephoto side), the control unit 140 transmits a control signal to the first zoom drive unit 115 to change the zoom magnification to low (wide-angle side). The first zoom drive unit 115 changes a lens position to the wide-angle side based on the control signal from the control unit 140.

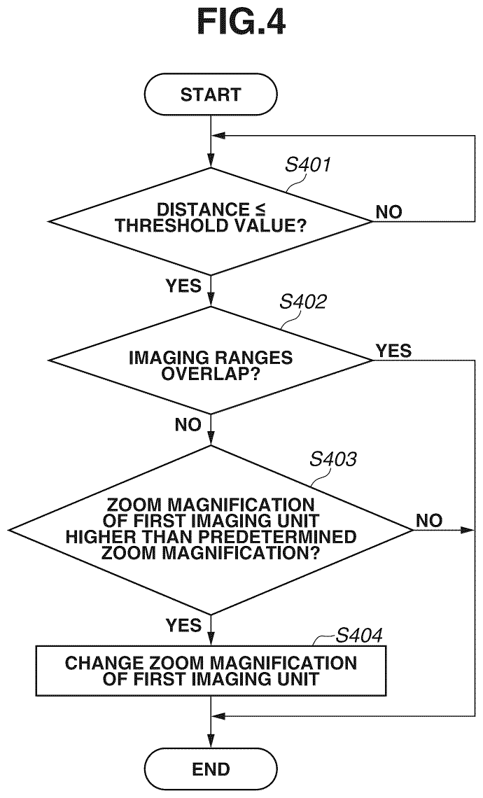

Processing performed by the imaging apparatus 100 according to the present exemplary embodiment will be described with reference to a flowchart in FIG. 4. The processing in the present flowchart is realized by the control unit 140 executing a program loaded to a random access memory (RAM). According to the present exemplary embodiment, it is assumed that a user performs an operation via the control apparatus 200 to move the first imaging unit 110. It is also assumed that the processing in the present flowchart starts after a certain time has elapsed since a control signal for moving the first imaging unit 110 is received via the control apparatus 200. Alternatively, it is assumed that the processing in the present flowchart starts when an instruction to complete installation of the first imaging unit 110 is received via the control apparatus 200.

Alternatively, it is assumed that the processing in the present flowchart starts when the imaging apparatus 100 receives a drive instruction even though the first imaging unit 110 to which a user transmits the drive instruction is not in a moving state.

In step S401, the determination unit 150 determines whether the first imaging unit 110 and the second imaging unit 120 are close to each other or contacting based on the distance between the first imaging unit 110 and the second imaging unit 120. Specifically, the determination unit 150 acquires information regarding the positions of the first imaging unit 110 and the second imaging unit 120 and determines whether the distance between the first imaging unit 110 and the second imaging unit 120 is less than or equal to the threshold value. If the determination unit 150 determines that the distance between the first imaging unit 110 and the second imaging unit 120 is less than or equal to the threshold value (YES in step S401), the processing proceeds to step S402. In other words, in a case where the first imaging unit 110 and the second imaging unit 120 are close to each other or contacting, the processing proceeds to step S402. As described above, it can also determine that they are close to each other or contacting if the rotation angles are the threshold value or less by using the rotation angles in the pan rotation direction of the first imaging unit 110 and the second imaging unit 120 without calculating the distance.

In a case where the determination unit 150 does not determine that the distance between the first imaging unit 110 and the second imaging unit 120 is less than or equal to the threshold value (NO in step S402), the processing returns to step S401.

In step S402, the control unit 140 acquires information regarding driving including the zoom magnifications from the first zoom drive unit 115 and the second zoom drive unit 125 to determine whether there is an overlap between the imaging ranges. In a case where there is no overlap between the imaging ranges (NO in step S402), the processing proceeds to step S403. In a case where there is an overlap between the imaging ranges (YES in step S402), the processing in the flowchart ends.

In step S403, the control unit 140 acquires the zoom magnification of the first imaging unit 110 operated by the user and determines whether the zoom magnification of the first imaging unit 110 is higher than a predetermined zoom magnification. In a case where the control unit 140 determines that the zoom magnification of the first imaging unit 110 is higher than the predetermined zoom magnification (YES in step S403), the processing proceeds to step S404. In a case where the control unit 140 determines that the zoom magnification of the first imaging unit 110 is not higher than the predetermined zoom magnification, that is, the zoom magnification is lower than or equal to the predetermined zoom magnification (NO in step S403), the processing ends. In other words, the control unit 140 determines whether the zoom magnification of the first imaging unit 110 is high (telephoto side). If it is high (telephoto side) (YES in step S403), the processing proceeds to step S404. In step S403, the zoom magnification of the first imaging unit 110 is acquired again, but the zoom magnification acquired in step S402 may also be used.

In step S404, the control unit 140 controls the first zoom drive unit 115 to change the zoom magnification to a low value (wide-angle side) such that the zoom magnification becomes lower than the predetermined zoom magnification. Specifically, the control unit 140 changes the zoom magnification of the first imaging unit 110 until the angle of view 116 (imaging range) of the first imaging unit 110 overlaps with the angle of view 126 (imaging range) of the second imaging unit 120, and then the processing ends. Alternatively, the processing is terminated when the zoom magnification of the first imaging unit 110 is changed to a state where zoom is not performed (the zoom magnification of 1 time), even if the angle of view 116 (imaging range) of the first imaging unit 110 and the angle of view 126 (imaging range) of the second imaging unit 120 do not overlap.

Whether the angle of view 116 (imaging range) of the first imaging unit 110 and the angle of view 126 (imaging range) of the second imaging unit 120 overlap with each other is calculated by the control unit 140 acquiring drive positions of the first imaging unit 110 and the second imaging unit 120 and calculating based on the acquired drive positions.

As described above, according to the present exemplary embodiment, an imaging apparatus in which each of a plurality of imaging units can independently rotate about a common rotation axis can appropriately set imaging ranges of the imaging units depending on a positional relationship between the plurality of imaging units.

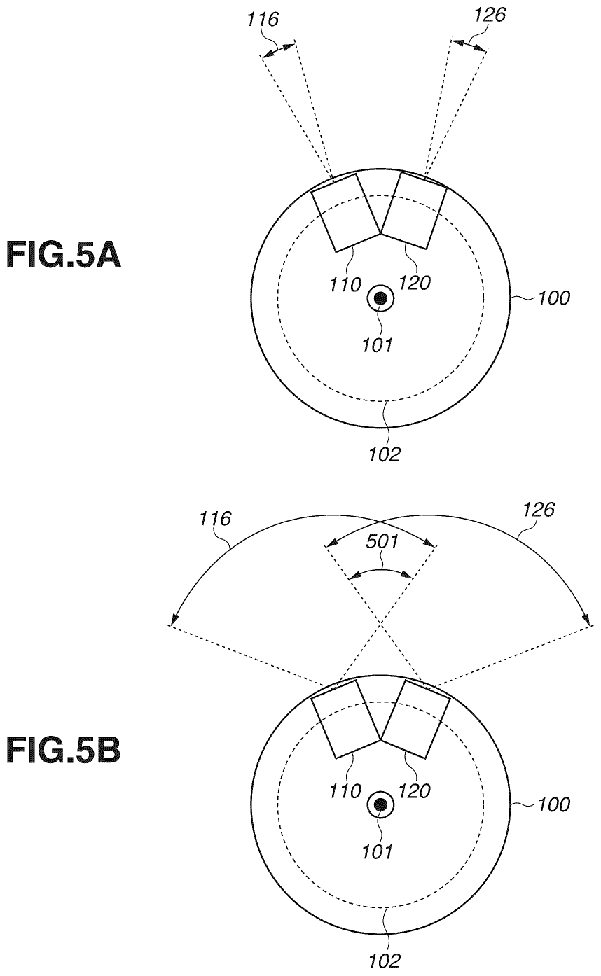

An operation of an imaging apparatus according to a second exemplary embodiment will be described below with reference to FIGS. 5A and 5B. According to the present exemplary embodiment, a case will be described in which the first imaging unit 110 is driven to pan by a user operation, which causes the first imaging unit 110 to contact the second imaging unit 120 that is not moving. According to the first exemplary embodiment, it is assumed that the second imaging unit 120 has already been installed, and the angle of view of the second imaging unit 120 is not changed. According to the present exemplary embodiment, however, it is assumed that the second imaging unit 120 is not installed yet.

FIG. 5A illustrates imaging ranges before angles of view of the imaging units according to the present exemplary embodiment are changed. FIG. 5B illustrates the imaging ranges after the angles of view of the imaging units according to the present exemplary embodiment are changed.

In more detail, FIG. 5A illustrates a state in which the first imaging unit 110 being operated by a user contacts the second imaging unit 120 in a case where the first imaging unit 110 and the second imaging unit 120 image at high zoom magnifications. In more detail, FIG. 5B illustrates imaging angles of view in a case where the first imaging unit 110 and the second imaging unit 120 are contacting in a state where both the first imaging unit 110 and the second imaging unit 120 do not perform zooming.

In other words, the first imaging unit 110 and the second imaging unit 120 can image such that their imaging ranges overlap in a range 501, but the imaging ranges may not overlap depending on the zoom magnification. However, when it is determined that the first imaging unit 110 comes close to or contacts the second imaging unit 120, it is desirable to change the angles of view by imaging such that the angle of view 116 (imaging range) and the angle of view 126 (imaging range) overlap in the range 501.

Thus, according to the present exemplary embodiment, in a case where the determination unit 150 determines that the first imaging unit 110 and the second imaging unit 120 contact or come close to each other, the zoom magnifications of the first imaging unit 110 and the second imaging unit 120 are changed to the wide-angle side. According to the present exemplary embodiment, the zoom magnification of the first imaging unit 110 as well as the zoom magnification of the second imaging unit 120 is changed. Specifically, the first zoom drive unit 115 changes the lens position to the wide-angle side based on a control signal from the control unit 140. Similarly, the control unit 140 determines a zoom state of the second zoom drive unit 125, and, if the zoom magnification is on the telephoto side, transmits a control signal to the second zoom drive unit 125 to change the zoom magnification to the wide-angle side. The second zoom drive unit 125 changes the lens position to the wide-angle side based on the control signal from the control unit 140.

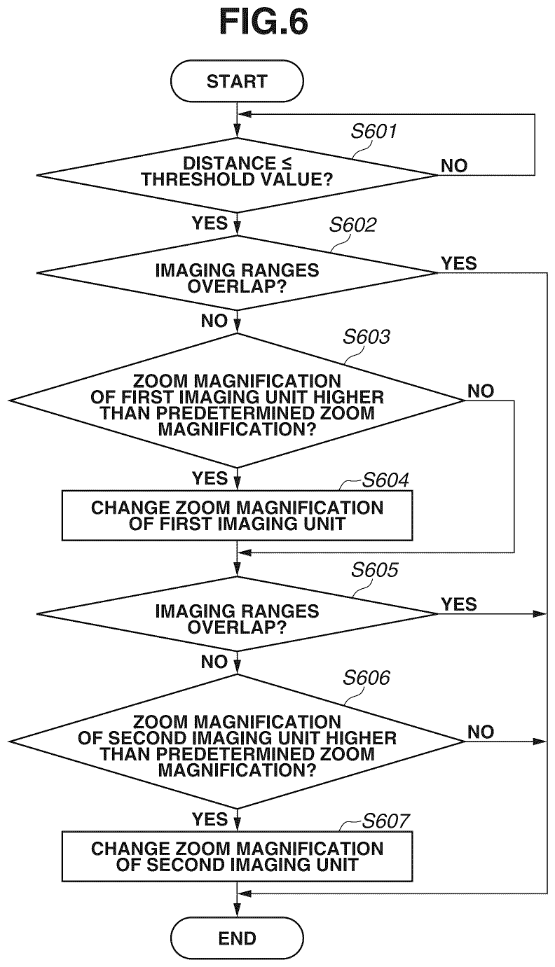

Processing by the imaging apparatus 100 according to the present exemplary embodiment will be described below with reference to a flowchart in FIG. 6. The processing in the present flowchart is realized by the control unit 140 executing a program loaded to the RAM. According to the present exemplary embodiment, it is assumed that a user performs an operation via the control apparatus 200 to move the first imaging unit 110. The user may perform an operation via the control apparatus 200 to move the second imaging unit 120. It is also assumed that the processing in the present flowchart starts when a certain time has elapsed since a control signal for moving the first imaging unit 110 is received via the control apparatus 200. Alternatively, it is assumed that the processing in the present flowchart starts when an instruction to complete installation of the first imaging unit 110 is received via the control apparatus 200.

Alternatively, it is assumed that the processing in the present flowchart starts while the imaging apparatus 100 is receiving a drive instruction even though the imaging unit to which a user transmits the drive instruction is not in a moving state.

In step S601, the determination unit 150 determines whether the first imaging unit 110 and the second imaging unit 120 are close to each other or contacting based on the information regarding the positions of the first imaging unit 110 and the second imaging unit 120. If the determination unit 150 determines that the distance between the first imaging unit 110 and the second imaging unit 120 is less than or equal to a threshold value (YES in step S601), the processing proceeds to step S602. In other words, in a case where the first imaging unit 110 and the second imaging unit 120 are close to each other, the processing proceeds to step S602. In a case where the determination unit 150 does not determine that the distance between the first imaging unit 110 and the second imaging unit 120 is less than or equal to the threshold value (NO in step S601), the processing returns to step S601.

In step S602, the control unit 140 acquires drive information including the zoom magnifications from the first zoom drive unit 115 and the second zoom drive unit 125 to determine whether there is an overlap between the imaging ranges. In a case where there is no overlap between the imaging ranges (NO in step S602), the processing proceeds to step S603. In a case where there is an overlap between the imaging ranges (YES in step S602), the processing in the flowchart ends.

In step S603, the control unit 140 acquires the zoom magnification of the first imaging unit 110 operated by the user to determine whether the zoom magnification of the first imaging unit 110 is higher than the predetermined zoom magnification. In a case where the control unit 140 determines that the zoom magnification of the first imaging unit 110 is higher than the predetermined zoom magnification (YES in step S603), the processing proceeds to step S604. In a case where the control unit 140 determines that the zoom magnification of the first imaging unit 110 is not higher than the predetermined zoom magnification, that is, the zoom magnification is the predetermined zoom magnification or less (NO in step S603), the processing proceeds to step S605. In other words, the control unit 140 determines whether the zoom magnification of the first imaging unit 110 is high (telephoto side), and if it is high (telephoto side) (YES in step S603), the processing proceeds to step S604. In step S603, the zoom magnification of the first imaging unit 110 is re-acquired, but the zoom magnification acquired in step S602 may also be used.

In step S604, the control unit 140 controls the first zoom drive unit 115 to change the zoom magnification to a low value (wide-angle side) such that the zoom magnification is reduced. Specifically, the control unit 140 changes the zoom magnification of the first imaging unit 110 until the angle of view 116 (imaging range) of the first imaging unit 110 overlaps with the angle of view 126 (imaging range) of the second imaging unit 120, and the processing proceeds to step S605. Alternatively, the processing proceeds to step S605 when the zoom magnification of the first imaging unit 110 is changed to a state where zoom is not performed, even if the angle of view 116 (imaging range) of the first imaging unit 110 does not overlap with the angle of view 126 (imaging range) of the second imaging unit 120.

Whether the angle of view 116 (imaging range) of the first imaging unit 110 and the angle of view 126 (imaging range) of the second imaging unit 120 overlap with each other is determined by the control unit 140 acquiring the positions and the angles of view of the first imaging unit 110 and the second imaging unit 120 in the pan rotation direction and calculating based on the acquired positions and angles of view in the pan rotation direction.

In step S605, the control unit 140 acquires the drive information including the zoom magnifications from the first zoom drive unit 115 and the second zoom drive unit 125 and determines whether there is an overlap between the imaging ranges. In a case where there is no overlap between the imaging ranges (NO in step S605), the processing proceeds to step S606. In a case where there is an overlap between the imaging ranges (YES in step S605), the processing ends.

In step S606, the control unit 140 acquires the zoom magnification of the second imaging unit 120 and determines whether the zoom magnification of the second imaging unit 120 is higher than the predetermined zoom magnification. In a case where the control unit 140 determines that the zoom magnification of the second imaging unit 120 is higher than the predetermined zoom magnification (YES in step S606), the processing proceeds to step S607. In a case where the control unit 140 determines that the zoom magnification of the second imaging unit 120 is not higher than the predetermined zoom magnification, that is, the zoom magnification is lower than the predetermined zoom magnification (NO in step S606), the processing ends.

In step S607, the control unit 140 controls the second zoom drive unit 125 to change the zoom magnification to a low value (wide-angle side) such that the zoom magnification is reduced. Specifically, the control unit 140 changes the zoom magnification of the second imaging unit 120 until the angle of view 116 (imaging range) of the first imaging unit 110 overlaps with the angle of view 126 (imaging range) of the second imaging unit 120, and then the processing ends. Alternatively, the processing in the flowchart ends if the zoom magnification of the second imaging unit 120 is changed to a state where zoom is not performed (the zoom magnification is one), even if the angle of view 116 (imaging range) of the first imaging unit 110 does not overlap with the angle of view 126 (imaging range) of the second imaging unit 120.

As described above, according to the present exemplary embodiment, an imaging apparatus in which each of a plurality of imaging units can independently rotate about a common rotation axis can appropriately set imaging ranges of the imaging units depending on a positional relationship between the plurality of imaging units.

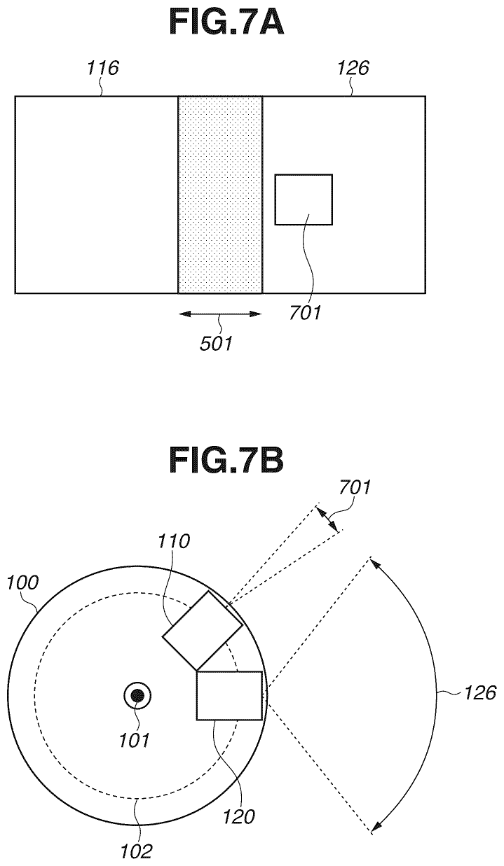

An operation of an imaging apparatus according to a third exemplary embodiment will be described below with reference to FIGS. 7A and 7B. According to the present exemplary embodiment, the first drive unit 113 and the second drive unit 123 each also include a tilt drive unit that can drive independently. FIG. 7A illustrates the angle of view 116 (imaging range) of the first imaging unit 110, the angle of view 126 (imaging range) of the second imaging unit 120, and the overlapping range 501 thereof illustrated in FIG. 5B. In other words, FIG. 7A illustrates the angles of view after the angle of view 116 of the first imaging unit 110 and the angle of view 126 of the second imaging unit 120 are changed to the wide-angle side in a case where it is determined that a user operates the first imaging unit 110, and the first imaging unit 110 and the second imaging unit 120 contact. It is assumed that the user has issued an instruction from the instruction unit 204 to change the angle of view of the first imaging unit 110 to a range 701 after the angle of view is changed to the wide-angle side illustrated in FIG. 7A.

In this case, as illustrated in FIG. 7B, it is desirable to drive the second imaging unit 120 to control the first imaging unit 110 to image the range 701 specified by the user. Specifically, the control unit 140 first transmits a control signal to the second pan drive unit 124 to move the second imaging unit 120 to acquire a pan driving amount of the first imaging unit 110 required to image the range 701 and to secure the drive position of the first imaging unit 110. A drive amount to move the second imaging unit 120 is set so as not to overlap with a position required for imaging with the first imaging unit 110.

The control unit 140 then transmits a control signal for imaging the range 701 with the first imaging unit 110 to the first zoom drive unit 115, the first pan drive unit 114, and a first tilt drive unit (not illustrated). The first pan drive unit 114 and the first tilt drive unit are driven based on the control signal and face in a direction of the range 701.

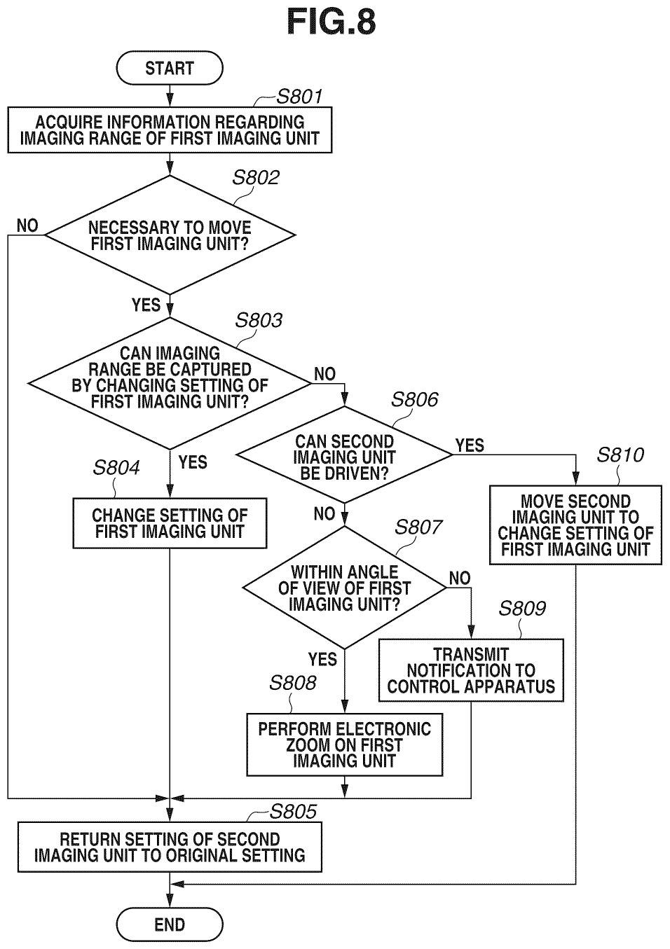

A processing flow of the imaging apparatus 100 according to the present exemplary embodiment will be described below with reference to FIG. 8. Processing in the present flow is executed after the processing flow in FIG. 6 ends. The processing in the present flowchart is realized by the control unit 140 executing a program loaded to the RAM.

In step S801, the control unit 140 acquires information regarding the imaging range (range 701) of the first imaging unit 110 specified by the user from the instruction unit 204.

In step S802, the control unit 140 determines whether it is necessary to move the first imaging unit 110 to image the specified range 701. If the control unit 140 determines that it is not necessary to move (NO in step S802), the processing proceeds to step S805. In a case where the control unit 140 determines that it is necessary to move (YES in step S802), the processing proceeds to step S803.

In step S803, the control unit 140 acquires information about the first pan drive unit 114, the first zoom drive unit 115, and the first tilt drive unit (not illustrated) for imaging the range 701 by the first imaging unit 110. The control unit 140 also determines whether the range 701 can be imaged by changing a setting of the first imaging unit 110 without moving the position of the second imaging unit 120 based on the drive position of the first pan drive unit 114. If the control unit 140 determines that the range 701 can be imaged by changing the setting of the first imaging unit 110 (YES in step S803), the processing proceeds to step S804. If the control unit 140 determines that the range 701 cannot be imaged (NO in step S803), the processing proceeds to step S806. The “setting” of the first imaging unit 110 described herein refers to at least one of a pan position, a tilt position, or the zoom magnification (optical zoom magnification) of the first imaging unit 110.

In step S804, the control unit 140 transmits a control signal to the first pan drive unit 114, the first zoom drive unit 115, and the first tilt drive unit to change the setting of the first imaging unit 110 and image the range 701. The processing then proceeds to step S805.

In step S805, the control unit 140 returns the setting of the second imaging unit 120 to its original setting. The original setting refers to the setting before the setting of the second imaging unit 120 is changed in the processing flow illustrated in FIG. 6. The “setting” of the second imaging unit 120 described herein refers to at least one of the pan position or the zoom magnification of the second imaging unit 120. After the setting is returned to the original setting, the processing flow ends.

In step S806, the control unit 140 determines whether the second imaging unit 120 can be driven. The determination as to whether the second imaging unit 120 can be driven may be made by the user from the instruction unit 204 or may be made when it is detected that the second imaging unit 120 has not been set. If it is determined that the second imaging unit 120 cannot be driven (NO in step S806), the processing proceeds to step S807. If it is determined that the second imaging unit 120 can be driven (YES in step S806), the processing proceeds to step S810.

In step S807, the control unit 140 determines whether the range 701 is within the angle of view of the first imaging unit 110. If the range 701 is within the angle of view of the first imaging unit 110 (YES in step S807), the processing proceeds to step S808. If the range 701 is out of the angle of view of the first imaging unit 110 (NO in step S807), the processing proceeds to step S809.

In step S808, the control unit 140 performs electronic zoom processing that performs enlargement without moving the lens on the range 701 from the angle of view of the first imaging unit 110. The processing then proceeds to step S805.

In step S809, the control unit 140 transmits to the control apparatus 200 a notification indicating that the first imaging unit 110 cannot be set to image the range 701. The processing then proceeds to step S805.

In step S810, the control unit 140 first transmits a control signal for operating the second pan drive unit 124 and moves the second imaging unit 120. Next, the control unit 140 transmits a control signal to the first pan drive unit 114, the first zoom drive unit 115, and the first tilt drive unit to change the setting of the first imaging unit 110, and images the range 701. The “setting” of the first imaging unit 110 described herein refers to at least one of the pan position, the tilt position, or the zoom magnification (optical zoom magnification), of the first imaging unit 110. The processing flow is then terminated.

As described above, according to the third exemplary embodiment, an imaging apparatus in which each of a plurality of imaging units can independently rotate about a common rotation axis can appropriately set imaging ranges of the imaging units depending on a positional relationship between the plurality of imaging units.

In step S402 according to the above-described exemplary embodiment, it is determined whether the imaging range of the first imaging unit 110 and the imaging range of the second imaging unit 120 overlap. However, this step may be skipped.

According to the above-described exemplary embodiments, the control unit 140 automatically changes the zoom magnification of the first imaging unit 110. However, it may also be possible for a user to change the zoom magnification if the imaging units come close to each other. Specifically, the display unit 203 of the control apparatus 200 may display (notify) that the imaging units come close to each other, and the user may change the zoom magnification. At this time, the user determines whether the angle of view 116 of the first imaging unit 110 and the angle of view 126 of the second imaging unit 120 overlap while viewing the image.

Alternatively, the zoom magnification may be changed in conjunction with a pan operation of the first imaging unit 110 without displaying (notifying) that the imaging units contact on the display unit 203 of the control apparatus 200. Specifically, the instruction unit 204 of the control apparatus 200 includes a user interface that instructs the pan drive unit to operate and a user interface that instructs the zoom drive unit to operate respectively, in a case where the imaging units are not in contact. However, in a case where the imaging units are in contact, the instruction unit 204 links a zoom operation to the user interface of the pan drive unit. In other words, when a user continues to instruct pan driving while the imaging units come close to each other, the zoom is gradually changed to the wide-angle side. Alternatively, when the pan operation is stopped, the zoom operation may also be stopped, and when the pan operation is performed in an opposite direction, the zoom magnification may be gradually changed to the telephoto side.

In a case where the determination unit 150 determines that the first imaging unit 110 and the second imaging unit 120 contact, for example, a composite image may also be generated, in which an image captured by the first imaging unit 110 and an image captured by the second imaging unit 120 are arranged adjacent to each other. Alternatively, an overlapping range of the angles of view may be displayed to be superimposed on respective display screens.

The first drive unit 113 and the second drive unit 123 may each also include a tilt drive unit that can drive independently. In a case where the determination unit 150 determines that the first imaging unit 110 and the second imaging unit 120 contact, the control unit 140 may acquire tilt angles of the respective imaging units and change the tilt position of the first imaging unit 110 operated by a user to match the tilt angle of the second imaging unit 120.

Each functional unit of the imaging apparatus 100 illustrated in FIG. 1 may also be implemented by hardware or software (computer program). Each functional unit may also be implemented by hardware such as an application specific integrated circuit (ASIC) or a programmable logic array (PLA). Some of the functional units may be implemented by hardware.

A computer device that can execute such a computer program can be applied to the imaging apparatus 100. An example of a hardware configuration of a computer device that can be applied to the imaging apparatus 100 will now be described.

The CPU 140 (control unit 140) executes various types of processing by using a computer program and data stored in the RAM or a read-only memory (ROM). The CPU 140 thereby controls the operation of the computer device, and also executes or controls the various types of processing described as the processing performed by the imaging apparatus 100. Instead of the CPU 140, a programmable processor such as a micro processing unit (MPU) may be used.

The RAM includes an area for storing a computer program and data loaded from the ROM or a storage device, and an area for storing a computer program and data received from outside via an interface (I/F). The RAM also includes a work area that the CPU 140 uses in executing various types of processing. In this way, the RAM can appropriately provide various areas.

The ROM stores setting data for the computer device, a computer program and data related to startup of the computer device, a computer program and data related to a basic operation of the computer device, and the like.

The storage device is a large-capacity information storage device such as a hard disk drive device. The storage device stores an operating system (OS), a computer program and data for causing the CPU 140 to execute or control various types of processing described as the processing performed by the imaging apparatus 100, and the like. The computer program stored in the storage device can also include a computer program for causing the CPU 140 to execute or control the functions of the functional units illustrated in FIG. 1. The data stored in the storage device can also include the above-described threshold value.

The CPU 140, the RAM, the ROM, and the storage device are all connected to a system bus. The hardware configuration of the computer device that can be applied to the imaging apparatus 100 is not limited to the above-described one and can be modified or changed appropriately.

While the present disclosure has been described with reference to exemplary embodiments, it is to be understood that the present disclosure is not limited to the above-described exemplary embodiments, and various modifications and changes can be made within the scope of the gist of the present invention.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-030013, filed Feb. 29, 2024, which is hereby incorporated by reference herein in its entirety.

What is claimed is:

1. An imaging apparatus comprising:
a first imaging unit and a second imaging unit configured to rotate about a common rotation axis;
a zoom drive unit configured to drive zoom lenses to change a zoom magnification of the first imaging unit and a zoom magnification of the second imaging unit;
a pan drive unit configured to rotate the first imaging unit and the second imaging unit about the common rotation axis;
one or more memories storing instructions; and
one or more processors executing the instructions to determine whether the first imaging unit and the second imaging unit are close to each other or contacting,
wherein, in a case where it is determined that the first imaging unit and the second imaging unit are close to each other or contacting, the zoom drive unit is controlled to change at least one of the zoom magnification of the first imaging unit or the zoom magnification of the second imaging unit.

2. The imaging apparatus according to claim 1, wherein the one or more processors execute the instructions to determine whether the first imaging unit and the second imaging unit are close to each other or contacting based on a distance between the first imaging unit and the second imaging unit.

3. The imaging apparatus according to claim 1, wherein the one or more processors execute the instructions to determine whether the first imaging unit and the second imaging unit are close to each other or contacting based on a threshold value that is a distance in a pan rotation direction between the first imaging unit and the second imaging unit.

4. The imaging apparatus according to claim 1,
wherein the one or more processors execute the instructions to determine whether the zoom magnification of the first imaging unit is higher than a predetermined zoom magnification, and
wherein, in a case where it is determined that the zoom magnification of the first imaging unit is higher than the predetermined zoom magnification, the zoom drive unit is controlled such that the zoom magnification of the first imaging unit becomes lower than the predetermined zoom magnification.

5. The imaging apparatus according to claim 4, wherein the one or more processors execute the instructions to determine whether the zoom magnification of the second imaging unit is higher than the predetermined zoom magnification after the zoom drive unit is controlled such that the zoom magnification of the first imaging unit becomes lower than the predetermined zoom magnification.

6. The imaging apparatus according to claim 1,
wherein the one or more processors execute the instructions to determine whether there is an overlap between an imaging range of the first imaging unit and an imaging range of the second imaging unit, and
wherein, in a case where it is determined that there is no overlap, the zoom drive unit is controlled such that the zoom magnification of the first imaging unit becomes lower than a predetermined zoom magnification.

7. The imaging apparatus according to claim 6, wherein, in a case where it is determined that the zoom magnification of the second imaging unit is higher than the predetermined zoom magnification, the zoom drive unit is controlled such that the zoom magnification of the second imaging unit becomes lower than the predetermined zoom magnification.

8. The imaging apparatus according to claim 7, wherein the one or more processors generate a composite image from images captured after the zoom magnifications of the first imaging unit and the second imaging unit are changed.

9. The imaging apparatus according to claim 1, wherein the first imaging unit and the second imaging unit are driven by the pan drive unit to come close to each other or contact.

10. The imaging apparatus according to claim 1, further comprising a tilt drive unit configured to drive the first imaging unit and the second imaging unit to tilt,
wherein information regarding an imaging range to be imaged by the first imaging unit is received via an external apparatus, and
wherein, in a case where it is determined that the imaging range can be imaged by changing settings of the first imaging unit, a setting of the pan drive unit, a setting of the tilt drive unit, and a setting of the zoom drive unit that are for the first imaging unit are changed to image the imaging range.

11. The imaging apparatus according to claim 1, further comprising a tilt drive unit configured to drive the first imaging unit and the second imaging unit to tilt,
wherein information regarding an imaging range to be imaged by the first imaging unit is received via an external apparatus, and
wherein, in a case where it is not determined that the imaging range can be imaged by changing settings of the first imaging unit, a setting of the pan drive unit, a setting of the tilt drive unit, and a setting of the zoom drive unit that are for the first imaging unit are changed to image the imaging range after the second imaging unit is driven.

12. The imaging apparatus according to claim 1, further comprising a tilt drive unit configured to drive the first imaging unit and the second imaging unit to tilt,
wherein, in a case where it is determined that the first imaging unit and the second imaging unit are close to each other or contacting, the tilt drive unit is driven to match a tilt angle of the first imaging unit with a tilt angle of the second imaging unit.

13. The imaging apparatus according to claim 1, wherein the one or more processors execute the instructions to receive drive instructions with respect to the pan drive unit for each of the first imaging unit and the second imaging unit via an external apparatus.

14. The imaging apparatus according to claim 1, wherein the one or more processors execute the instructions to transmit image data acquired by the first imaging unit and the second imaging unit to an external apparatus.

15. A method for controlling an imaging apparatus that comprises a first imaging unit and a second imaging unit configured to rotate about a common rotation axis, a zoom drive unit configured to drive zoom lenses to change a zoom magnification of the first imaging unit and a zoom magnification of the second imaging unit, and a pan drive unit configured to rotate the first imaging unit and the second imaging unit about the common rotation axis, the method comprising:
determining whether the first imaging unit and the second imaging unit are close to each other or contacting; and
controlling, in a case where it is determined that the first imaging unit and the second imaging unit are close to each other or contacting, the zoom drive unit to change at least one of the zoom magnification of the first imaging unit or the zoom magnification of the second imaging unit.

16. A non-transitory computer readable storage medium storing a program for causing a computer to execute a method for controlling an imaging apparatus that comprises a first imaging unit and a second imaging unit configured to rotate about a common rotation axis, a zoom drive unit configured to drive zoom lenses to change a zoom magnification of the first imaging unit and a zoom magnification of the second imaging unit, and a pan drive unit configured to rotate the first imaging unit and the second imaging unit about the common rotation axis, the method comprising:
determining whether the first imaging unit and the second imaging unit are close to each other or contacting; and
controlling, in a case where it is determined that the first imaging unit and the second imaging unit are close to each other or contacting, the zoom drive unit to change at least one of the zoom magnification of the first imaging unit or the zoom magnification of the second imaging unit.
